(19) United States
(12) Patent Application Publication
(10) Pub. No.: US 2002/0019179 A1
(43) Pub. Date: Feb. 14, 2002

(54) Electrical connector

(76) Inventor: Toshio Masumoto, Tokyo (JP)

Correspondence Address: J. Warren Whitesel, MICHAEL BEST & FRIEDRICH LLC, 401 North Michigan Avenue, Chicago, IL, 60611, US

(21) Appl. No.: 09/925,986

(22) Filed: Aug. 9, 2001

(30) Foreign Application Priority Data
Aug. 10, 2000 (JP) 242189/2000

(51) Int. Cl. H01R 4/48

(52) U.S. Cl. 439/862

(57) ABSTRACT

In an electrical connector having at least one contact (2) held in at least one contact accommodating groove (3a) formed in an insulator (3), the contact (2) comprises a base portion (21) press-fitted in the contact accommodating groove (3a), a contact portion (22) projecting (2a) from the contact accommodating groove (3a) upward, and a U-shape spring portion (2b) connecting the base portion (21) and the contact portion (22). The contact accommodating groove (3a) comprises a relatively large width section (3a-1) adjacent to the end wall (3e) and a relatively small width section (3a-2) adjacent to the open end. Opposite side walls at the relatively small width section (3a-2) are formed with press-fit grooves (3d) adjacent to the bottom wall (3c). The base portion (21) of the contact (2) is formed with lateral projections (2c) laterally projecting from the opposite sides of the base portion (21), and the lateral projections (2c) are press-fit in the press-fit grooves (3d) respectively. The base portion (21) of the contact (2) has a slender part which extends between the U-shape spring portion (2b) and the lateral projections (2c) and which is smaller in width than the width of the relatively small width section (3a-2) of the contact accommodating groove (3a).

### BACKGROUND OF THE INVENTION

This invention relates to an electrical connector which connects a printed circuit board to another printed circuit board, a flexible printed circuit, a liquid crystal display, etc.

A conventional electrical connector will be described referring to FIGS. 1, 2, and 3. The conventional electrical connector is described in Japanese Unexamined Patent Publication (JP-A) No. 102758 of 1999.

A main body 31 of the connector is a generally rectangular parallelepiped-shaped insulator which is molded of resin. The main body 31 has a plurality of grooves 33 formed therein parallel to one another. Thus, each of the grooves is defined by a bottom wall 32, an upper wall 35 confronting the bottom wall 32, and opposite side walls. The upper wall 35 is provided with a plurality of openings 34. The bottom wall 32 is provided with an accommodating space 36 connecting with the groove 33. The side walls are provided with press-fit grooves 37 along the both sides of the groove 33, respectively.

Each of a plurality of contacts 41 are inserted into each of the grooves 33, respectively. Each of the contacts 41 is made of elastic copper alloy to a long plate-shape. Each contact 41 has a base portion 42 and a contact portion 43 narrower than the base portion 42, both of which are connected to each other through a U-shape bent portion 41a. The contact portion 43 can elastically displaced around the bent portion 41a. The contact portion 43 is provided with a projecting portion 43a which is formed by bending the contact portion 43 in the vicinity of a free end of the contact portion 43 into an inverted V-shape. The base portion 42 has a rectangular accommodating hole 42a under the contact portion 43. When the contact portion 43 is downward displaced about the bent portion 41a, it passes through the accommodating hole 42a and is received in the accommodating space 36. Two triangular press-fit projections 42b are formed at both sides of the crosswise direction of the base portion 42, respectively, and are fitted into the press-fit grooves 37, respectively. The base portion 42 is provided with a terminal portion 44 at an end opposite to the bent portion 41a.

FIG. 1 shows the state that the connector is mounted on the surface of a first printed circuit board 51. The main body 31 is supported on the first printed circuit board 51 and the terminal potion of each of the contacts 41 is connected and fixed to a circuit pattern (not shown) on the first printed circuit board 51. The projecting portion 43a of the contact 41 protrudes by the height h from the upper surface of the confronting wall 35 of the main body 31.

Now, a second printed circuit board 52 to be connected to the first printed circuit board 51 through the connector is disposed at the distance d away from the surface of the first printed circuit board 51, and is in contact with the projecting portion 43a of the contact 41. Then, the second printed circuit board 52 is pushed down to the first printed circuit board 51, the contact portion 43 of the contact 41 deforms elastically from the position shown by the solid line to the position shown by the two dots-chain line in FIG. 1. The second printed circuit board 52 stops at the position when the lower surface thereof has run against the upper surface of the upper wall 35. At this time, a circuit pattern (not shown) of the second printed circuit board 52 connects with the circuit pattern (not shown) of the first printed circuit board 51 by way of a route from the projecting portion 43a of the contact 41, through the contact portion 43, the base portion 42, and the terminal portion 44.

In the conventional connector, a stroke of the projection portion 43 moved by the second printed circuit board 52 pushed down is sufficiently large because of the provision of the accommodating hole 42a and accommodating space 36. At that time, the contact portion 43 is lowered through the accommodating hole 42a below the base portion 42 as shown by the imaginary line and a curvature of the bent portion 41 is therefore increased so that the bent portion 41a may unfortunately be plastically deformed. In order to avoid the undesired plastic deformation of the bent portion 41a, it is desired to increase the width of the bent portion 41a. However, the width of the bent portion 41a is limited as described below. In assembling the conventional electrical connector, the press-fit projections 42b are formed so as to guide the contact 41 press-fitted into the main body 31 of the connector, in cooperation with the press-fit grooves 37 formed in the main body 31. Therefore, the width of the bent portion 41a of the contact 41 cannot be formed with a size greater than an interval between the opposite side walls of the grooves 33 where the press-fit grooves 37 are formed.

Further, since the base portion 42 is provided with the accommodating hole 42a through which the contact portion 43 passes, widths of the base portion 42 and the groove 33 cannot be made so small so that the connector is impossible to be made with a small size as desired.

### SUMMARY OF THE INVENTION

It is therefore an object of this invention to provide an electrical connector having a plurality of contacts with a compact size wherein the contacts are stably held, and have excellent elasticity with a desired stroke of contact region of the contact portion.

This invention is applicable to an electrical connector having at least one contact held in at least one contact accommodating groove formed in an insulator, the contact accommodating groove defined by a bottom wall, opposite sidewalls, and an end wall and being open upward and at the opposite end, the contact comprising a base portion press-fitted in the contact accommodating groove, a contact portion projecting from the contact accommodating groove upward, and a U-shape spring portion connecting the base portion and the contact portion.

In the electrical connector according to this invention:

the contact accommodating groove comprises a relatively large width section adjacent to the end wall and a relatively small width section adjacent to the open end;

the opposite side walls at the relatively small width section being formed with press-fit grooves adjacent to the bottom wall;

the base portion of the contact being formed with lateral projections laterally projecting from the opposite sides of the base portion, the lateral projections being press-fit in the press-fit grooves respectively; and

the base portion of the contact has a slender part which extends between the U-shape spring portion and the lateral projections and which is smaller in width than the width of the relatively small width section of the contact accommodating groove.

The U-shape spring portion of the contact preferably has a width less than but approximately equal to the width of the relatively large width section of the contact accommodating groove.

The contact portion of the contact preferably has a width smaller than the U-shape spring portion, and the contact portion is slantingly and upward bent at a bent portion apart from the U-shape spring portion and is folded to form a U-shaped folded portion projecting slantingly and upward.

According to another embodiment, the electrical connector has a plurality of the contacts which are accommodated in a plurality of contact accommodating grooves, respectively.

In an embodiment, the plurality of contact accommodating grooves are arranged at both sides of a central partitioning wall and in parallel with each other in each of the sides.

The end wall of each of the plurality of contact accommodating grooves is preferably defined by the partitioning wall.

The partitioning wall preferably has a top end with small flange portions oppositely therefrom to the contact accommodating grooves at both sides of the partitioning wall, the top end and the flange portion forming a flat upper surface.

### BRIEF DESCRIPTION OF THE DRAWINGS

FIG. 1 is a sectional view of a conventional electrical connector;

FIG. 2 is a perspective view of the conventional electrical connector;

FIG. 3 is a perspective view of a contact of the conventional electrical connector;

FIG. 4A is a plan view of an electrical connector according to an embodiment of this invention;

FIG. 4B is a front view of the electrical connector according to the embodiment of this invention;

FIG. 4C is a side view of the electrical connector according to the embodiment of this invention;

FIG. 4D is a bottom view of the electrical connector according to the embodiment of this invention;

FIG. 5 is a perspective view of the electrical connector according to the embodiment of this invention;

FIG. 6 is a perspective view of a contact and an insulator of the electrical connector according to the embodiment of this invention, before they are assembled together;

FIG. 7A is a plan view of a first step of the assembling process of the electrical connector according to the embodiment of this invention;

FIG. 7B is a sectional view of the first step the assembling process of the electrical connector according to the embodiment of this invention;

FIG. 7C is a plan view of a second step of the assembling process of the electrical connector according to the embodiment of this invention;

FIG. 7D is a sectional view of the second steep of the assembling process of the electrical connector according to the embodiment of this invention;

FIG. 8A is a sectional view of the electrical connector according to the embodiment of this invention;

FIG. 8B is a sectional view of another electrical connector according to another embodiment of this invention;

FIG. 9A is a sectional view of the electrical connector according to the embodiment of this invention for describing a process connecting two printed circuit boards to each other with a single contact deforming elastically; and

FIG. 9B is a partially sectioned side view of the electrical connector having two rows of contacts shown therein in a state on the way of the connecting process shown in FIG. 9A.

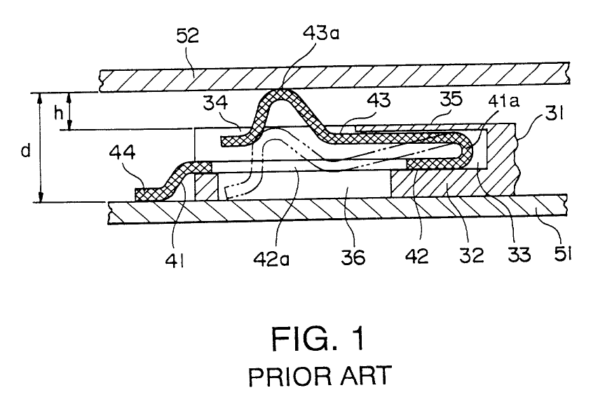

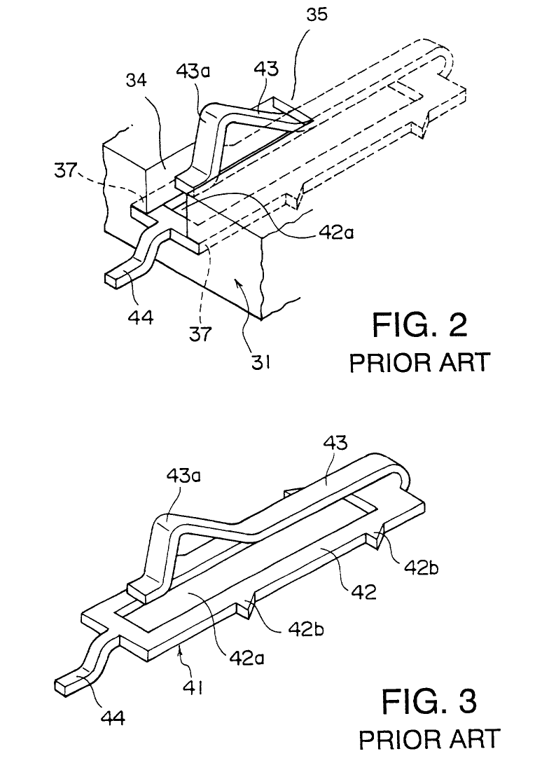

### DESCRIPTION OF THE PREFERRED EMBODIMENT

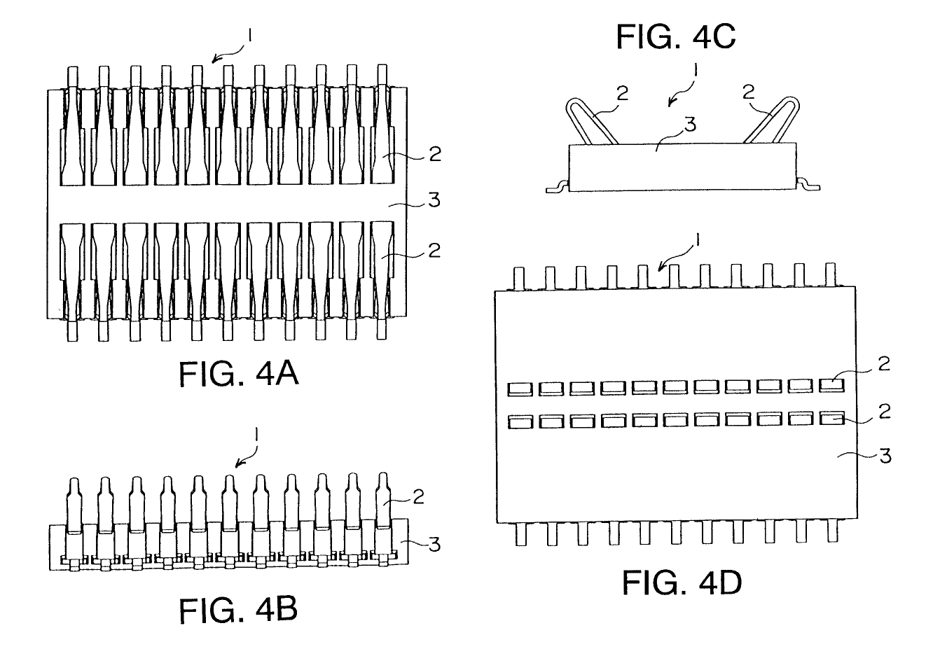

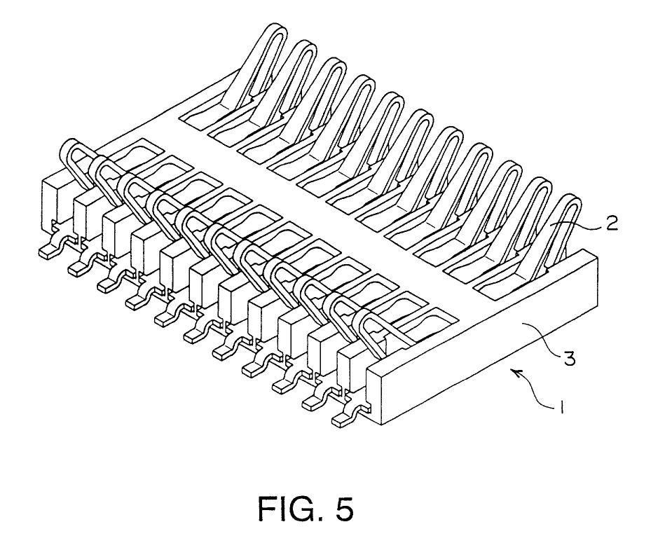

Referring now to FIGS. 4A to 8A, the description will proceed to an electrical connector according to a preferred embodiment of this invention. As shown in FIGS. 4A to 5, a connector 1 comprises a plurality of contacts 2 disposed oppositely in two rows and an insulator 3 holding the contacts 2.

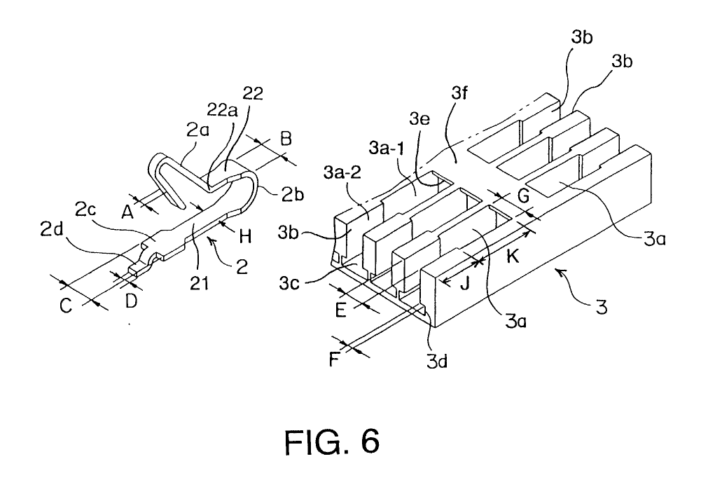

As shown in FIG. 6, each of contacts 2 comprise a base portion 21, a contact portion 22 having a U-shaped projection 2a slantingly projecting upward at a free end thereof, and a generally U-shaped spring portion 2b connecting an end of the base portion 21 and the opposite end of the contact portion 22.

In detail, the contact portion 22 has a shape where it is bent upwardly and slantingly at a bent portion 22a to form a slant portion and the slant portion is folded into a U-shape to form the slanting U-shaped projection 2a.

The base portion 21 is provided with, as press-fit portions 2c, two lateral projections laterally projecting from opposite sides adjacent to the opposite end thereof and a terminal portion 2d at the opposite end. The lateral projections or press-fit portions 2c are press fit into press-fit grooves 3d in the insulator 3. The terminal portion 2d is soldered to a circuit pattern on a printed circuit board (11 in FIG. 9A).

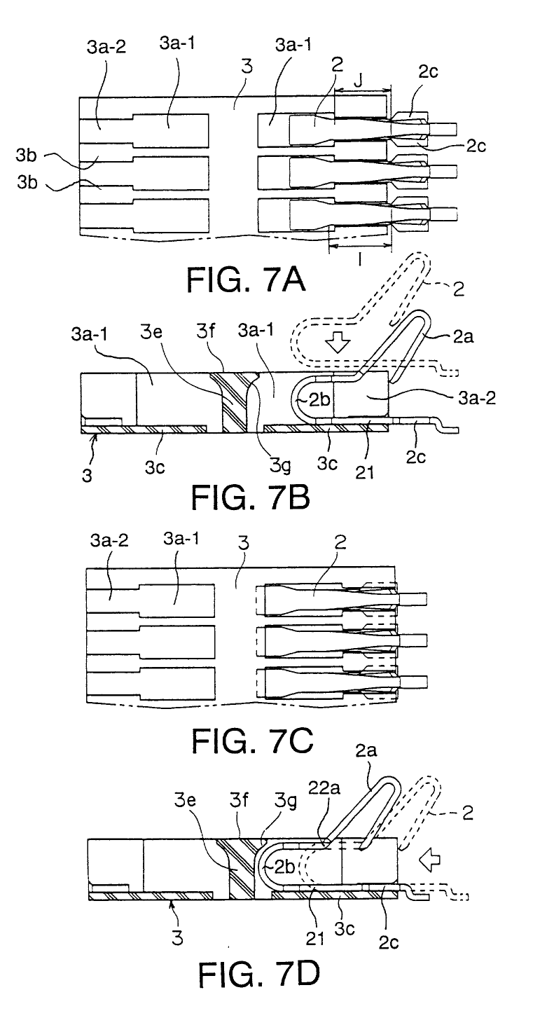

Referring to FIGS. 7A-7D in addition, the insulator 3 is provided with a plurality of contact accommodating grooves 3a which are disposed symmetrically at both sides of a central partitioning wall 3e and extend in parallel with each other at each of the sides. The partitioning wall 3e has a top end with a small flanges 3g slightly protruding in the opposite directions to the adjacent contact accommodating grooves 3a. Thus, the top end of the partitioning wall 3e has a relatively large flat surface 3f extending over the flange 3g. Each of the contact accommodating grooves 3a is for accommodating each of the contacts 2 and is defined by a bottom wall 3c and opposite side walls so that it is open upward and has an open end opposite to the partitioning wall 3e. A pair of projections 3b are formed on the opposite side walls at portions adjacent to the open end with small gaps 3d being left between the bottom wall 3c and lower surface of the projections 3b. Therefore, the contact accommodating groove 3a has a relatively large width section 3a-1 adjacent to the partitioning wall 3e and a relatively small width section 3a-2 adjacent to the open end. The small gaps 3d are for receiving the press-fit portions 2c of the contact 2 and will therefore be referred to as press-fit grooves, hereinafter.

The size relations on several portions of both the contact 2 and the insulator 3 are as follows. Assuming that the width of the contact portion 22 is A, the maximum width of the spring portion 2b is B, the maximum width of the press-fit portion 2c is C, the width of the terminal portion 2d is D, the width of the small width section 3a-2 is E, the depth of the press-fit groove 3d is F, the width of the large width section 3a-1 is G, and the width of the base portion 21 of the contact 2 is H, those width sizes have the following relations: A<B, A<C, B<C, B>E, B<G, C>D, E<C, C>E+2F, E<G and H<E. Further, a length of I of the base portion 21 of the contact 2 from the spring portion 2b to the lateral projections 2c (see FIG. 7A) is larger than a length J of the small width section 3a-2 of the contact accommodating groove, that is I>J. A length K of the large width section 3a-1 of the contact accommodating groove 3a is determined so that the spring portion 2b and at least one part of the base portion 21 of the contact 2 can be accommodated therein.

In another embodiment, B can be made equal to or larger than C. Moreover, C can be made equal to or smaller than E+2F.

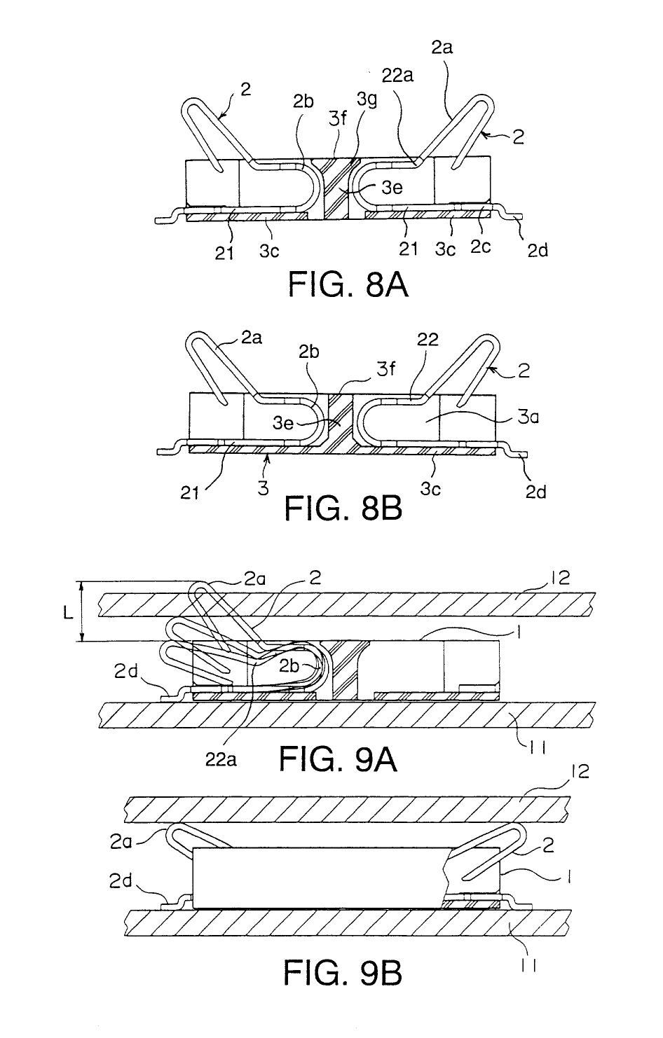

Referring to FIGS. 7A-7D, the description will be made as to the assembling of contact 2 into the insulator 3. At first, the contact 2 is positioned above the contact accommodating groove 3a at a state shown by a broken line in FIG. 7B so that a part of the base portion 21 of the contact 2 between the spring portion 2b and the lateral projections 2c is in registry with the small width section 3a-2 of the contact accommodating groove 3a while the U-shape spring portion 2b is in registry with the large width section 3a-1 of the contact accommodating groove 3a, as shown in FIGS. 7A and 7B. Then, the contact 2 can be inserted into the contact accommodating groove 3a by moving the contact 2 downward, that is, in a direction shown by a blank arrow direction to a position shown by a solid line as shown in FIG. 7B. Then, the base portion 21 is in contact with the base wall 3c of the contact accommodating groove 3a. Next, the contact 2 is pushed into the contact accommodating groove 3a along the bottom wall 3c until the spring portion 2b is brought into contact with the partitioning wall 3e. That is, in FIG. 7D, the contact 2 positioning at a state shown by a broken line is moved to a position shown by a solid line toward a blank arrow direction. At that time, the lateral projections 2c is press fit in the press-fit grooves 3d, respectively. Thus, the contact 2 is completely assembled in the insulator 3 as shown in FIG. 7C. FIG. 8A shows a state two rows of contacts 2 are completely assembled in the contact accommodating grooves at opposite sides of the partitioning wall 3e. The spring portion 2b of the contact 2 is positioned just under the flange portion 3g. The U-shaped projection 2a of the contact portion 22 extends slanting upward.

The connector assembled can be surface-mounted on a printed circuit board (11, in FIGS. 9A and 9B) by the use of vacuum chucking device where a chucking nozzle is brought into contact with the top portion 3f of the insulator 3 shown in FIG. 8A and is chucked.

Another connector shown in FIG. 8B is different from that of the embodiment of this invention shown in FIG. 8A. That is, the flanges 3g in FIG. 8A are omitted, if the top surface 3f of the partitioning wall 3e without the flanges 3g is insured large sufficient to receive the chucking nozzle.

Referring to FIGS. 9A and 9B, in the state where the connector is mounted on the first printed circuit board 11, terminal portions 2d are electrically and mechanically connected to circuit patterns (not shown) on the first printed circuit board 11. A second printed circuit board 12 to be connected to the first printed circuit board 11 is disposed so that circuit patterns (not shown) of the second printed circuit board 12 are brought into contact with the U-shaped portions 2a of the contacts 2. Next, the second printed circuit board 12 is pushed down toward the first printed circuit board 11. Thereupon, each of the contacts 2 elastically deforms so that the top end of the U-shaped portion 2a of the contact portion 22 is brought into press-contact with the circuit pattern of the second printed circuit board. FIG. 9A shows the different three shapes of the contact portion 22. The first one is a first shape thereof without deformation. The second one is a shape on a way of the deformation of the contact portion 22 where spring portion 2b is slightly increased in its curvature and the bent portion 22a is slightly open. Thus, the U-shaped projection 2a is reduced in its slant angle. The third one is a final shape in a state where the second printed circuit 12 is pushed onto the upper surface of the connector, or onto the top surface 3f of the partitioning wall 3e. The spring portion 2b has a further increased curvature and the bent portion 22a is further open. Therefore, the U-shaped portion 2a has a further reduced slant angle. As a result, the end of the U-shaped projection 2a is in contact with the second printed circuit 12 with a relatively large contact pressure which is generated by restoring forces at the bent portion 22a and the spring portion 2b deformed. Therefore, the circuit pattern of the second printed circuit board 12 can reliably be connected with the circuit pattern of the first printed circuit board 11 by way of the contact 2.

Further, the contact portion 22 is neither displaced below the base portion 21 and the spring portion 2b is therefore, nor excessively deformed. Further, the spring portion 2b can be formed with an increased width equal to the interval between the press-fit portions 2c. Therefore, there is not such a problem that the spring portion 2b is plastically deformed.

Moreover, since the base portion 21 is not necessary to have an accommodating hole which permits the contact portion 22 to displace below the base portion 21, the contact can be formed with a reduced width. Therefore, the connector can be formed with a further compact size.

The embodiments have been described in connection with two printed circuit boards 11 and 12, the connector according to this invention can be used for connecting other electronic devices with each other. For example, a LCD panel is used in place of the printed circuit board 12. A flexible printed circuit is also used in place of printed circuit board 11.

What is claimed is:

1. An electrical connector having at least one contact (2) held in at least one contact accommodating groove (3a) formed in an insulator (3), said contact accommodating groove (3a) defined by a bottom wall (3c), opposite sidewalls, and an end wall (3e) and being open upward and at the opposite end, said contact (2) comprising a base portion (21) press-fitted in the contact accommodating groove (3a), a contact portion (22) projecting (2a) from the contact accommodating groove (3a) upward, and a U-shape spring portion (2b) connecting the base portion (21) and the contact portion (22), wherein:
said contact accommodating groove (3a) comprises a relatively large width section (3a-1) adjacent to the end wall (3e) and a relatively small width section (3a-2) adjacent to the open end;
said opposite side walls at the relatively small width section (3a-2) being formed with press-fit grooves (3d) adjacent to the bottom wall (3c);
said base portion (21) of the contact (2) being formed with lateral projections (2c) laterally projecting from the opposite sides of the base portion (21), said lateral projections (2c) being press-fit in said press-fit grooves (3d) respectively; and
said base portion (21) of the contact (2) has a slender part which extends between said U-shape spring portion (2b) and said lateral projections (2c) and which is smaller in width than the width of the relatively small width section (3a-2) of the contact accommodating groove (3a).

2. An electrical connector as claimed in claim 1, wherein said U-shape spring portion (2b) of said contact (2) has a width less than but approximately equal to the width of said relatively large width section (3a-1) of the contact accommodating groove (3a).

3. An electrical connector as claimed in claim 2, wherein said contact portion (22) of said contact (2) has a width smaller than said U-shape spring portion (2b), and said contact portion (22) is slantingly and upward bent at a bent portion apart from said U-shape spring portion and is folded to form a U-shaped folded portion (2a) projecting slantingly and upward.

4. An electrical connector as claimed in claim 3, wherein a plurality of said contacts (2) are accommodated in a plurality of contact accommodating grooves (3a), respectively.

5. An electrical connector as claimed in claim 4, wherein said a plurality of contact accommodating grooves (3a) are arranged at both sides of a central partitioning wall (3e) and in parallel with each other in each of the sides.

6. An electrical connector as claimed in claim 5, wherein said end wall of each of said plurality of contact accommodating grooves (3a) is defined by said partitioning wall (3e).

7. An electrical connector as claimed in claim 6, wherein said partitioning wall has a top end with small flange portions (3g) oppositely therefrom to said contact accommodating grooves (3a) at both sides of said partitioning wall (3e), said top end and said flange portion forming a flat upper surface (3f).

8. An electrical connector having a plurality of contacts (2) held in a plurality of contact accommodating grooves (3a) formed in an insulator (3), respectively, each of said contact accommodating grooves (3a) being defined by a bottom wall (3c), opposite sidewalls, and an end wall (3e) and being open upward and at the opposite end, each of said contacts (2) comprising a base portion (21) press-fitted in a corresponding one of the contact accommodating grooves (3a), a contact portion (22) projecting (2a) from the corresponding contact accommodating groove (3a) upward, and a U-shape spring portion (2b) connecting the base portion (21) and the contact portion (22), wherein:
each of said contact accommodating grooves (3a) comprises a relatively large width section (3a-1) adjacent to the end wall (3e) and a relatively small width section (3a-2) adjacent to the open end;
said opposite side walls at the relatively small width section (3a-2) are formed with press-fit grooves (3d) adjacent to the bottom wall (3c);
said base portion (21) of the contact (2) are formed with lateral projections (2c) laterally projecting from the opposite sides of the base portion (21), said lateral projections (2c) being press-fit in said press-fit grooves (3d) respectively; and
said base portion (21) of the contact (2) has a slender part which extends between said U-shape spring portion (2b) and said lateral projections (2c) and which is smaller in width than the width of the relatively small width section (3a-2) of the contact accommodating groove (3a).

9. An electrical connector as claimed in claim 8, wherein said U-shape spring portion (2b) of said contact (2) has a width less than but approximately equal to the width of said relatively large width section (3a-1) of the contact accommodating groove (3a).

10. An electrical connector as claimed in claim 9, wherein said contact portion (22) of said contact (2) has a width smaller than said U-shape spring portion (2b), and said contact portion (22) is slantingly and upward bent at a bent portion apart from said U-shape spring portion and is folded to form a U-shaped folded portion (2a) projecting slantingly and upward.

11. An electrical connector as claimed in claim 8, wherein said a plurality of contact accommodating grooves (3a) are arranged at both sides of a central partitioning wall (3e) and in parallel with each other in each of the sides.

12. An electrical connector as claimed in claim 11, wherein said end wall of each of said plurality of contact accommodating grooves (3a) is defined by said partitioning wall (3e).

13. An electrical connector as claimed in claim 12, wherein said partitioning wall has a top end with small flange portions (3g) oppositely therefrom to said contact accommodating grooves (3a) at both sides of said partitioning wall (3e), said top end and said flange portion forming a flat upper surface (3f).

14. An electrical connector having a plurality of contacts (2) for use in electrical connection of a first connection object (11) with a second connection object (12) so that said electrical connector being electrically and mechanically mounted while said second connector being brought into contact with said contacts (2) having at least one contact (2), said electrical connector comprising:
an insulator (3) having a plurality of contact accommodating groove (3a) formed in an insulator (3) for accommodating said contacts, respectively;
each of said contact accommodating grooves (3a) defined by a bottom wall (3c), opposite sidewalls, and an end wall (3e) and being open upward and at the opposite end,
each of said contact accommodating grooves (3a) comprising a relatively large width section (3a-1) adjacent to the end wall (3e) and a relatively small width section (3a-2) adjacent to the open end; and
said opposite side walls at the relatively small width section (3a-2) being formed with press-fit grooves (3d) adjacent to the bottom wall (3c); and
each of said contact (2) comprising a base portion (21) supported on said base wall (3c) of the corresponding one of said contact accommodating grooves (3a), a contact portion (22) projecting (2a) from the contact accommodating groove (3a) upward, and a U-shape spring portion (2b) connecting the base portion (21) and the contact portion (22);
said base portion (21) of the contact (2) being formed with lateral projections (2c) laterally projecting from the opposite sides of the base portion (21), said lateral projections (2c) being press-fit in said press-fit grooves (3d) respectively; and
said base portion (21) of the contact (2) having a slender part which extends between said U-shape spring portion (2b) and said lateral projections (2c) and which is smaller in width than the width of the relatively small width section (3a-2) of the contact accommodating groove (3a);
said U-shape spring portion (2b) of said contact (2) having a width less than but approximately equal to the width of said relatively large width section (3a-1) of the contact accommodating groove (3a); and
said contact portion (22) of said contact (2) having a width smaller than said U-shape spring portion (2b), and said contact portion (22) being slantingly and upward bent at a bent portion apart from said U-shape spring portion and is folded to form a U-shaped folded portion (2a) projecting slantingly and upward.

15. An electrical connector as claimed in claim 14, wherein said a plurality of contact accommodating grooves (3a) are arranged at both sides of a central partitioning wall (3e) and in parallel with each other in each of the sides.

16. An electrical connector as claimed in claim 15, wherein said end wall of each of said plurality of contact accommodating grooves (3a) is defined by said partitioning wall (3e).

17. An electrical connector a claimed in claim 16, wherein said partitioning wall has a top end with small flange portions (3g) oppositely therefrom to said contact accommodating grooves (3a) at both sides of said partitioning wall (3e), said top end and said flange portion forming a flat upper surface (3f).
